(19) United States
(12) Patent Application Publication
(10) Pub. No.: US 2006/0239441 A1
(43) Pub. Date: Oct. 26, 2006

(54) Method and system for blending of reactive and active contacts

(76) Inventors: Denny Yang, Arlington, TX (US); Saeed Contractor, Pembroke Pines, FL (US); Madhusudhana K. Mathur, Miami, FL (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/098,911

(22) Filed: Apr. 4, 2005

(51) Int. Cl. H04M 3/00

(52) U.S. Cl. 379/265.11

(57) ABSTRACT

A system and method for blending reactive contacts and active contacts are disclosed. The exemplary method identifies a list of available agents to receive a reactive media contact from an automated contact distributor. The method receives the reactive contact by the automated contact distributor. The method determines a preferred agent from the list of available agents to receive the first reactive contact. The method indicates to the automated contact distributor that only the preferred agent is available to connect with the reactive contact

### TECHNICAL FIELD OF THE INVENTION

The present invention relates to the field of contact communication handling and more particularly, to a method and system for blending of reactive media contacts and active media contacts.

### BACKGROUND

An Automatic Call Distribution system (ACD) may be used to distribute incoming contacts among a plurality of agents. When an ACD receives a contact, the ACD identifies an agent to handle the contact based on a set of defined rules stored internal to the ACD. The ACD then connects the contact to the agent identified by the rules. Exemplary types of contacts may include telephone contacts, e-mail contacts, and chat contacts).

The ACD may be designed to handle only one type of contact. A system of this design may require a separate ACD for each type of contact. A single ACD may also be designed to handle more than one type of contact. The ACD may even combine contacts from a traditional Public Switched Telephone Network (PSTN) with contacts from a Data Network Telephony (DNT) and even contacts from a Private Branch exchange (PBX) system.

In addition to the ACD system handling contacts, an internal contact management system or router in a call center may be used to control receiving and forwarding contacts. The contact management system consults a common data repository, stores the status of agents, and routes all contacts according to a single set of rules internal to the call center.

The contact management system may even provide agents with the enhanced ability to handle multiple types of communications in a consistent manner. The contact management system may receive information related to contacts and display this information in the call center and queue list. Agents can select contacts for further processing from the information presented in a queue list.

As a call center expands and integrates new technologies, it is possible for a call center to implement multiple ACD systems and even combine multiple ACD systems with contact management systems. For example, multiple external ACDs may be implemented to handle external contacts and a contact management system may be implemented to handle internal contacts. The external ACDs may route contacts to agents based on the rules stored internally to ACD. The contact management system may route internal calls based on rules stored within the call center. The contact management system is able to actively receive and route the internal contacts based on the information associated with the contact. This may be referred to as active media blending. The cell center processor may also receive contacts routed from the external ACD. For these contacts, the contact management system receives the contact from the ACD and must react to the contact. From the point of view of the contact management system, the processor does not route the contact based on current status of the call center but must react to the received call. This may be referred to as reactive media blending. The system allows multiple components to be incorporated into a call center.

However, the systems do not efficiently blend active and reactive media. Distribution of active media is performed without any knowledge of what else is going on in the reactive media and vice versa. The problems with these types of systems are that the external ACDs do not interact with each other and contacts are routed to the first available agent without regard the agent's status relative to other contacts received by the contact management system.

Therefore, there is a need for an effective and efficient method and system for blending reactive media with inactive media in a contact center. There is a need for a system and method that modifies a reactive media system, making it an active system.

### SUMMARY OF THE INVENTION

The present invention is a novel system and method for blending reactive media and active media in a contact center. The system features automatic contact distribution systems for receiving contacts across various media types. The system stores the contacts in a queue and a multimedia contact management system prioritizes the contacts in the queue according to a priority scheme. The multimedia contact management system controls the transfer of the contacts from the automatic contact distribution system to the agents.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a system diagram of a communication network used to efficiently blend reactive media contacts and active media contacts in a multi-media contact center according to the present invention.

FIG. 2 is a flow chart illustrating a first exemplary embodiment of the invention.

FIG. 3 is a flow chart illustrating a second exemplary embodiment of the invention.

FIG. 4 is a flow chart illustrating a third exemplary embodiment of the invention.

### DETAILED DESCRIPTION

The present invention features methods and systems for matching active media contacts and reactive media contacts to agents in a call center. The methods and systems may be implemented in a contact management system of a call center. The methods and systems of the invention provide a contact management system that can actively route contacts based on rules stored within the call center. The methods and systems also allow the contact management system to route reactive contacts in an active manner based on the same rules as the active contacts or other rules stored within the call center.

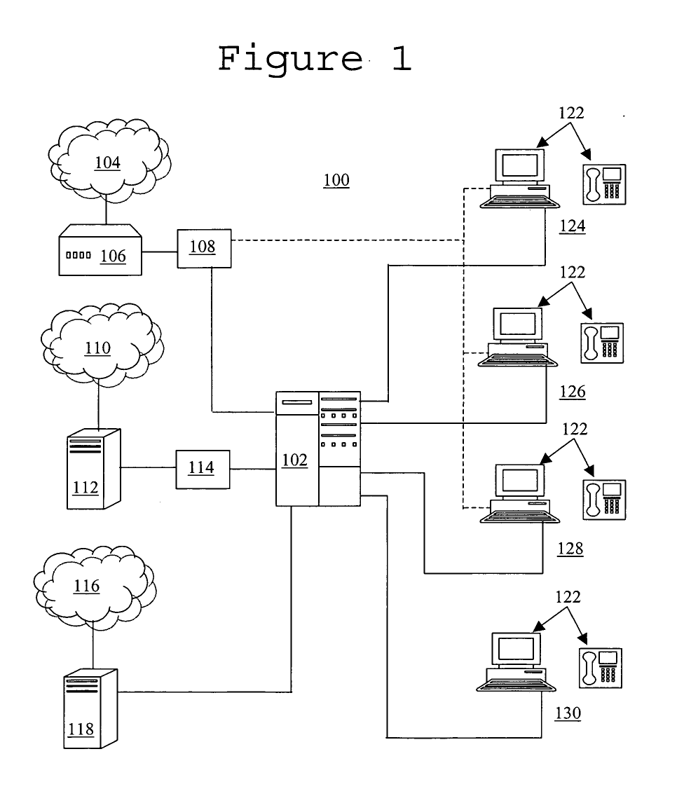

FIG. 1 is a system diagram of a communication network 100 used for efficiently blending reactive media contacts and active media contacts. Contacts from various points of the communication network are routed to agents of a call center 102. The contacts may be in a variety of formats, for example but not limited to, the form of telephone calls, emails, chat messages, or video.

In the exemplary system of FIG. 1, the contacts may originate from a PSTN network 104. Telephone switches 106 receive the telephone call and route it to a telephone ACD 108. The telephone ACD 108 receives the telephone call and routes the telephone call to a preferred agent from a list of available agents based on rules stored within the telephone ACD 108. The telephone ACD 108 may receive the list of available agents from a contact management system 102 within the call center. The telephone ACD 108 connects the telephone call to the preferred agents determined based on rules inside the telephone ACD.

The telephone ACD 108 connects the call via the communication link represented by the dashed lines in FIG. 1. The telephone ACD 108 of the communication system 100 may not connect to all agents. The telephone ACD 108 may not have enough switch capacity handle all the agents or the other agents may be coupled to other external ACDs. The telephone ACD 108 also has a connection to the contact management system 102. This connection allows the contact management system 102 to communicate with the telephone ACD 108 and supply contact connections to the telephone ACD 108.

The contacts may also originate from other networks within the communication network. Email contacts or DNT contacts may originate from a first IP network 110. The contacts are sent from a first IP network server 112 to a first IP ACD 114. Similar to the telephone ACD 108, the first IP ACD 114 may receive a list of available agents from the contact management system 102 of the call center and selects the preferred agent. The first IP ACD 114 determines the preferred agent among the list of available agents based on a set of rules stored within the first IP ACD 114. The first IP ACD 114 then connects the contact with the preferred agent. Similar to the telephone ACD 108, the first IP ACD 114 may have communication links (not shown) to connect the contacts to the agents. Similar to the telephone ACD 108, the first IP ACD 114 may not connect to all agents in the call center. The first IP ACD 114 also has a connection to the contact management system 102. This connection allows the contact management system 102 to communicate with the first IP ACD 114 and supply contact connections to the first IP ACD 114.

The contacts may also originate from a second IP network 116. The contacts are sent from a second IP server 118 directly to the contact management system 102. Unlike the first IP ACD 114 and the second IP ACD 120, the contact management system 102 may directly receive the contacts from the second IP server 118 and actively route the contacts to the preferred agent.

The contact management system 102 may connect a variety of communication devices 122 of agents in a call center. In the exemplary system of FIG. 1, four agents (a first agent 124, a second agent 126, a third agent 128, and a fourth agent 130) are available to receive contacts. Each of the four agents have communication devices 122 to receive contacts. In the example shown in FIG. 1, a computer and a telephone are the communication devices 122 used by the agents. The agents 124, 126, 128, 130 are not limited to the communication devices 122 shown in the exemplary system of FIG. 1. Other communication device may connect the agents 124, 126, 128, 130 to the contact management system 102.

The contact management system 102 may route contacts within the call center or from the second IP network 116. For example, an individual from the second IP network 116 may contact an agent in the call center. The contact management system receives the contact and determines the preferred agent for the contact. The contact management system 102 determines the preferred agent based on rules stored within the contact center. This type of contact may be defined as an active contact. The contact management system 102 is able to actively receive and route the contact based on the information associated with the contact. The active contacts are not limited to contacts from IP networks, as shown in the exemplary communication system 100. The contact management system 102 may also receive active contacts from other networks.

The contact management system 102 may also receive reactive contacts routed by the telephone ACD 108 and the IP ACDs 114 and 120. The contact management system 102 may actively route the reactive contacts from the ACDs 108, 114, 120 by sending a selective list of available agents to the ACDs 108, 114, 120. For example, the telephone ACD 108 may receive a telephone contact. The contact management system 102 may determine that both the first agent 126 and second agent 128 are available to receive the telephone contact, however, the second agent 128 is the preferred agent based on rules stored within the call center.

The contact management system 102 may actively route the telephone contact by signal to the telephone ACD 108 that only the second agent 126 is available to receive the telephone contact, even though technically both the first agent 124 and the second agent 126 are available. If given the option of both the first agent 124 and second agent 126 being available, the rules of the telephone ACD 108 may have selected the first agent 124 as the preferred agent. The telephone ACD 108 then would have connected the telephone contact to the first agent 124. However, because the contact management system 102 signaled to the telephone ACD 108 that only the second agent 126 is available, the telephone ACD 108 will route the telephone contact to the second agent 126. Since the second agent 126 is the only available agent, the rules of the telephone ACD 108 will direct the telephone ACD 108 to connect the telephone contact to the second agent 126 rather than the first agent 124. The contact management system 102 is able to actively route the reactive contact of the telephone ACD 108.

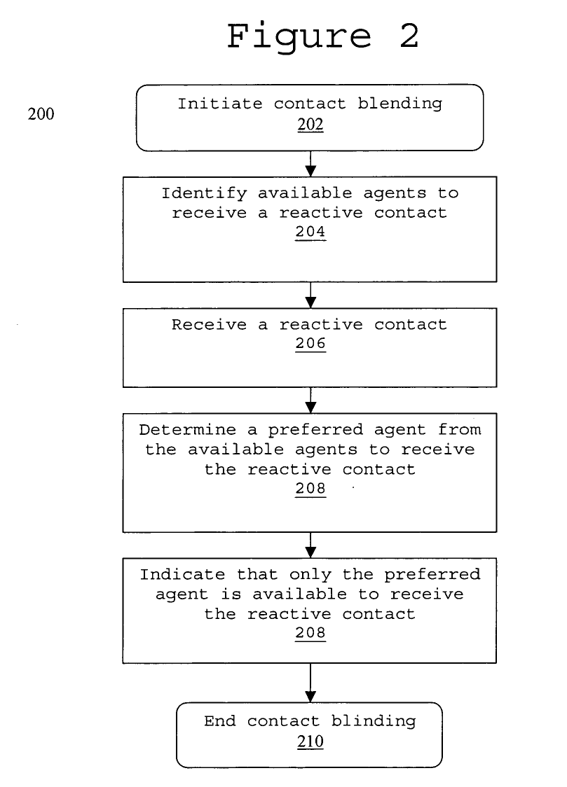

FIG. 2 is a flow chart illustrating a first exemplary embodiment 200 of the invention. The first exemplary embodiment 200 illustrates an exemplary method used by the contact management system to handle reactive contacts. The contact blending and routing is initiated (block 202). The contact management system identifies the available agents to receive a reactive media contact (block 204). A reactive contact is received by an ACD (block 206) coupled to the contact management system. The contact management system may be notified of the receipt of the contact ACD or notified of the potential to receive a contact. The contact management system determines a preferred agent from the list of available agents identified by the contact management system (block 208). The contact management system indicates to the ACD that only the preferred agent is available to receive the contact (block 208). The ACD couples the contact to the preferred agent and the contact blending is complete.

The contact management system may indicate to the ACD that only the preferred agent is available to receive the contact in a variety of manners. For example, but not limited to, the contact management system may routinely indicate that all other agents besides the preferred agent are unavailable to receive the contact of the ACD. In another example, the contact management system may take into account the rules stored within the ACD. In this example, the rules within the ACD may direct the ACD to couple the contact with the first agent if the first agent is available, couple the contact to the second agent if the first agent is unavailable, and couple the contact to the third agent if the first agent and second agent are unavailable. According to the example, the contact management system may take into account these rules internal to the ACD. If the contact management system determines based on rules internal to the call center that the second agent is the preferred agent, the contact management system may indicate that the first agent is unavailable knowing that the ACD's internal rules will then couple the contact to the second agent. The contact management system may use a variety of other methods to indicate the preferred agent to couple with the contact.

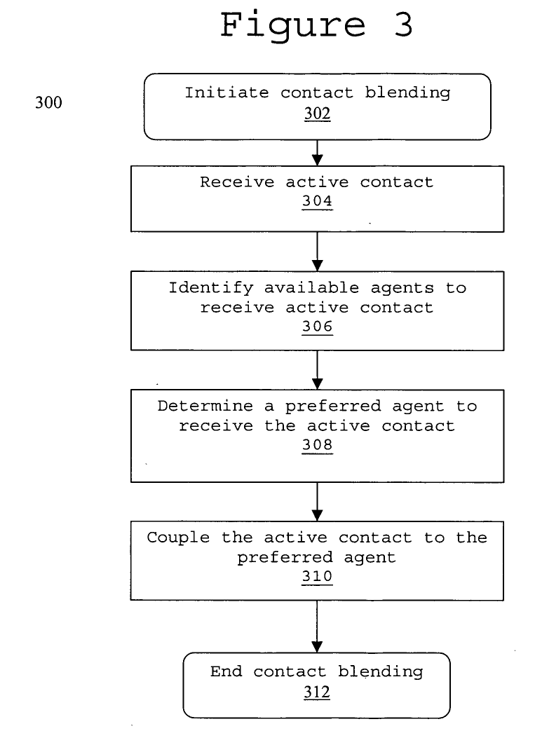

FIG. 3 is a flow chart illustrating a second exemplary embodiment of the invention. The second exemplary embodiment 300 illustrates an exemplary method used by the contact management system to handle active contacts. The contact blending and routing is initiated (block 302). An active contact is received by the contact management system or a router coupled to the contact management system (block 304). The contact management system identifies the available agents to receive the active media contact (block 306). The contact management system determines a preferred agent from the list of available agents identified by the contact management system (block 308). The contact management system couples or directs the router to couple the contact to the preferred agent (block 310). The contact blending is complete (block 312).

The contact management system may implement both the first exemplary embodiment 200 and the second exemplary embodiment 300. The contact management system may route both active and reactive contacts in an active manner based on rules internal to the contact management system. The internal rules may be stored in a database coupled to the contact management system. Along with the rules, the database may also store the list of available agents and attributes of each available agent to allow the system to determine the preferred agent for each active and reactive contact.

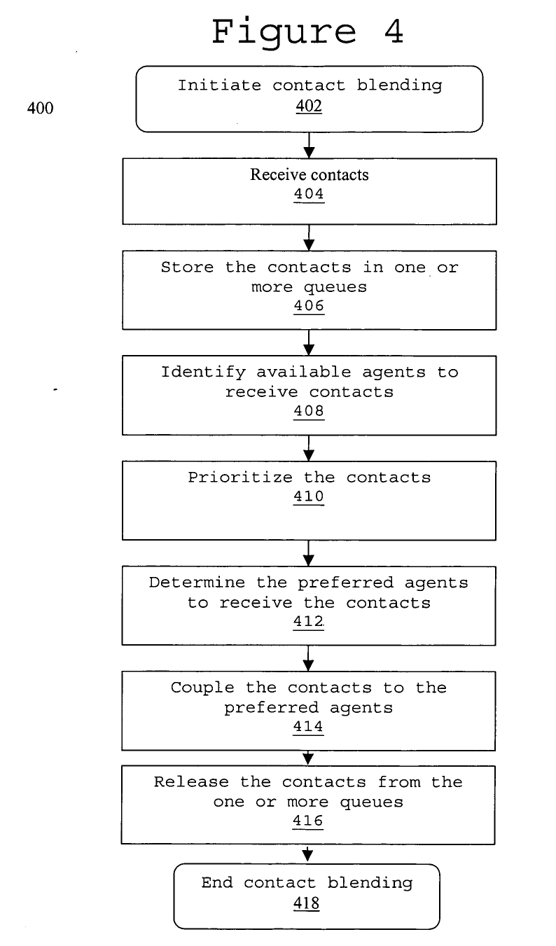

FIG. 4 is a flow chart illustrating a third exemplary embodiment 400 of the invention. The third exemplary embodiment 400 illustrates an exemplary method used by the contact management system to handle multiple reactive and active contacts. The contact blending and routing is initiated (block 402). Both reactive and active contacts are received by the contact management system or devices coupled to the contact management system (block 404). The contact management system stores the contacts in one or more queues (block 406). The one or more queues may be within a database coupled to the contact management system.

The contact management system may also store attributes for each contact to aid in a later determination of the preferred agent for the contact. The contact management system identifies the available agents to receive the contacts stored in the one or more queues (block 408). The contacts may be prioritized in the one or more queues based on the attributes of the contacts or other factors. The contact management system determines the preferred agent to receive each contact (block 410). The contact management system couples each media contact to the preferred agent for each contact (block 414). The contact management system may directly couple active contacts. The contact management system may also indicate to the ACD or contact routing devices that only the preferred agent is available to receive the reactive contact, as previously discussed in the first exemplary embodiment. As each contact is coupled to the determined preferred agent, the contact is released from the one or more queues (block 416) and the contact blending is complete (block 418).

The contact management system may be integrated into the call center 28 for blending a reactive contact system and active contact system. A suitable contact management system may be the EnsemblePro® created by Concerto® located at 6 Technology Drive Park in Westford, Mass. The call center in accordance with the present invention may be configured using any type of network infrastructure, such as, for example, asynchronous transfer mode (ATM), local area networks, wide area networks, Internet Protocol (IP) Networks, etc. The term “contact management system” as used herein is thus intended to include any type of ACD system, telemarketing system, or other communication system which processes contacts or other service requests, including voice calls, video calls, multimedia calls, e-mail, faxes, text chat or voice messages as well as various portions or combinations of these and other types of communications. The term “contact” as used herein is intended to include any of the above-noted types of communications as well as portions or combinations of these and other communications.

Although the exemplary embodiments of the invention are described in conjunction with the processing of contacts in an exemplary contact center, it is not limited to use with any particular type of contact method, call center or communication processing/contact center. For example, the invention is applicable to the processing of incoming communications, outgoing communications, or both. The disclosed techniques can be used with automatic call distribution (ACD) systems, telemarketing systems, private-branch exchange (PBX) systems, computer-telephony integration (CTI)-based systems, multi-media contact centers, as well as in combinations of these and other types of call centers.

The exemplary embodiments described herein can be implemented in digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a device or method which must satisfy one or more of any stated or implied object or feature of the invention and is not limited to the preferred, exemplary, or primary embodiment(s) described herein. Modifications and substitutions by one of ordinary skill in the art are considered to be within the scope of the present invention.

The invention claimed is:

1. A method of blending reactive and active contacts, the method comprising:
identifying a list of available agents to receive a first reactive contact from a first automated contact distributor;
receiving the first reactive contact by the first automated contact distributor;
determining a preferred agent from the list of available agents to receive the first reactive contact; and
indicating to the first automated contact distributor that only the preferred agent is available to couple with the first reactive contact.

2. The method of claim 1, further comprising:
indicating to the first automated contact distributor that all other agents besides the preferred agents on the list of available agents are unavailable.

3. The method of claim 1, further comprising:
receiving an active contact;
identifying a list of available agents to receive the active contact,
determining the preferred agent from the list of available agents to receive the active contact; and
coupling the active contact to the preferred agent determined to retrieve the active contact.

4. The method of claim 1, wherein the reactive contact types include a telephone contact, an email contact, and a chat contact.

5. The method of claim 1, further comprising:
identifying a list of available agents to receive a second reactive contact from a second automated contact distributor;
receiving the second reactive contact by the second automated contact distributor;
determining a preferred agent from the list of available agents to receive the second reactive contact; and
indicating to the second automated contact distributor that only the preferred agent to receive the second reactive contact is available to couple with the second reactive contact.

6. The method of claim 5, further comprising:
storing the first reactive contact and second reactive contact in one or more queues;
prioritizing the first reactive contact and second reactive contact in said one or more queues according to a priority scheme;
releasing the first reactive contact from the one or more queues when the first automated contact distributor couples the first reactive contact with the preferred agent for the first reactive contact; and
releasing the second reactive contact from the one or more queues when the second automated contact distributor couples the second reactive contact with the preferred agent for the second reactive contact.

7. The method of claim 1, wherein the first automated contact distributor receives reactive contacts from communication networks including publicly-switched telephone networks, Internet Protocol (IP) networks, and internet telephony networks.

8. A system of blending reactive and active contacts, the system comprising:
a first automated contact distributor for receiving a first reactive media contact and
a multimedia contact management system for identifying a list of available agents to receive the first reactive media contact from the first automated contact distributor, determining a preferred agent from the list of available agents to receive the first reactive media contact, and indicating to the first automated contact distributor that all other agents besides the preferred agents on the list of available agents are unavailable.

9. The system of claim 8, wherein the multimedia contact management system also indicates to the first automated contact distributor that only the preferred agent is available to connect with the first reactive media contact.

10. The system of claim 8, wherein the multimedia contact management system also receives an active media contact, identifies a list of available agents to receive the active media contact, determines the preferred agent from the list of available agents to receive the active media contact, and connects the active media contact to the preferred agent determined to retrieve the active media contact.

11. The system of claim 8, wherein the reactive media contact types include a telephone contact, an email contact, and a chat contact.

12. The system, of claim 8, further comprising:
a second automated contact distributor for identifying a list of available agents to receive a second reactive media contact, receiving the second reactive media contact by the second automated contact distributor, determining a preferred agent from the list of available agents to receive the second reactive media contact, and indicating to the second automated contact distributor that all other agents besides the preferred agents for the second reactive media contact on the list of available agents are unavailable.

13. The system of claim 12, wherein the multimedia contact management system also stores the first reactive media contact and second reactive media contact in one or more queues, prioritizes the first reactive media contact and second reactive media contact in said one or more queues according to a priority scheme, releases the first reactive media contact from the one or more queues when the first automated contact distributor couples the first reactive media contact with the preferred agent for the first reactive media contact, and releases the second reactive media contact from the one or more queues when the second automated contact distributor couples the second reactive media contact with the preferred agent for the second reactive media contact.

14. The system of claim 8, wherein the first automated contact distributor receives reactive media contacts from communication networks including publicly-switched telephone networks, Internet Protocol (IP) networks, and internet telephony networks.

15. A system of blending reactive and active media in a contact center, the system comprising:
means for identifying a list of available agents to receive a first reactive media contact from a first means for contact distribution;
means for receiving the first reactive media contact by the first means for contact distribution;
means determining a preferred agent from the list of available agents to receive the first reactive media contact; and
means for indicating to the first means for contact distribution that all other agents besides the preferred agents on the list of available agents are unavailable.

16. The system of claim 15, wherein the means for indicating to the first means for contact distribution indicates that only the preferred agent is available to connect with the first reactive media contact.

17. The system of claim 15, wherein:
the means for receiving also receives an active media contact; and
the means for identifying also identifies a list of available agents to receive the active media contact;
the means for determining also determines the preferred agent from the list of available agents to receive the active media contact; and
the means for connecting also connects the active media contact to the preferred agent determined to retrieve the active media contact.

18. The system of claim 15, wherein the reactive media contact types include a telephone contact, an email contact, and a chat contact.

19. The system of claim 15, wherein:
the means for identifying also identifies a list of available agents to receive a second reactive media contact from a second means for contact distribution;
the means for receiving also receives the second reactive media contact by the second means for contact distribution;
the means for determining also determines a preferred agent from the list of available agents to receive the second reactive media contact; and
the means for indicating also indicates to the second means for contact distribution that all other agents besides the preferred agents for the second reactive media contact on the list of available agents are unavailable.

20. The system of claim 19, further comprising:
a means for storing the first reactive media contact and second reactive media contact in one or more queues;
a means for prioritizing the first reactive media contact and second reactive media contact in said one or more queues according to a priority scheme;
a means for releasing the first reactive media contact from the one or more queues when the first means for contact distribution couples the first reactive media contact with the preferred agent for the first reactive media contact; and
a means for releasing the second reactive media contact from the one or more queues when the second means for contact distribution couples the second reactive media contact with the preferred agent for the second reactive media contact.
